(19) United States
(12) Patent Application Publication
(10) Pub. No.: US 2019/0130290 A1
(43) Pub. Date: May 2, 2019

(54) OBJECT ORIENTED SYSTEM AND METHOD HAVING SEMANTIC SUBSTRUCTURES FOR MACHINE LEARNING

(71) Applicant: DATA2DISCOVERY, Bloomington, IN (US)

(72) Inventors: Randy Gerard KERBER, San Jose, CA (US); Ying DING, Bloomington, IN (US); Brian FOOTE, Urbana, IL (US); David John WILD, Bloomington, IN (US)

(21) Appl. No.: 16/078,974

(22) PCT Filed: Feb. 24, 2017
(86) PCT No.: PCT/US17/19316

§ 371 Date: Aug. 22, 2018

Related U.S. Application Data
(60) Provisional application No. 62/299,310, filed on Feb. 24, 2016.

(51) Int. Cl. G06N 5/04; G06N 20/00; G06F 16/901; G06F 17/27

(52) U.S. Cl. CPC G06N 5/04; G06F 17/2785; G06F 16/9024; G06N 20/00

(57) ABSTRACT

The present invention involves a method, a system, and software for semantic analysis of disparate data in an environment having a plurality of datasets having distinct information fields. A candidate generation module involves creating graphs with information fields from the plurality of datasets as nodes, then creating smaller graphs containing source and sink vertices based on heuristic values. An electrical network computation module involves representing graphs as an electrical circuit to calculate the voltage of each node and the current of each edge by solving a system of linear equations. A diverse subgraph generation module involves selecting paths that carry the larger amount of current and have more new nodes in an iterative process. With each iteration, the path that scores the highest marginal current per number of existing types of nodes is selected and added to the diverse subgraph.

### CROSS-REFERENCE TO RELATED APPLICATIONS

The present application is a National Stage of PCT International Application Serial Number PCT/US17/19316, filed Feb. 24, 2017, and claims priority under 35 U.S.C. § 119(e) of U.S. Provisional Patent Application Ser. No. 62/299,310, filed Feb. 24, 2016, the disclosures of which are incorporated by reference herein.

### BACKGROUND OF THE INVENTION

### Field of the Invention

The invention relates to data analytics. More specifically, the present disclosure relates to computational methods, systems, devices and/or apparatuses for semantic data integration through machine learning based on semantic descriptors.

### Description of the Related Art

Resource Description Framework (RDF) is a standard model for data interchange on the Web. M′ has features that facilitate data merging even if the underlying schemas differ, and it specifically supports the evolution of schemas over time without requiring all the data consumers to be changed. RDF extends the linking structure of the Web to use Uniform Resource Identifiers (URI) to name the relationship between things as well as the two ends of the link (this is usually referred to as a “triple”). Using this simple model, it allows structured and semi-structured data to be mixed, exposed, and shared across different applications. This linking structure forms a directed, labeled graph, where the edges represent the named link between two resources, represented by the graph nodes. This graph view is the easiest possible mental model for RDF and is often used in easy-to-understand visual explanations.

The Semantic Web technologies mentioned above form one branch derived from Artificial Intelligence with the aim to represent data semantics for data integration and reuse. Another technology from Artificial Intelligence technologies is the field of machine learning. Machine learning contains two parts: feature selection and classification algorithms. Nowadays, classification algorithms are well-established and wildly adopted. These algorithms may be supervised or unsupervised. However, feature selection is viewed as the key component to advance the machine learning algorithms. Selecting right features is one of the key milestones to guarantee better machine learning output. But feature selection is operated unsystematically, which means that people either randomly select features or only select the direct features presented on the datasets.

### SUMMARY OF THE INVENTION

The present invention involves, in one embodiment, a method for semantic analysis of disparate data in an environment having a plurality of datasets having distinct information fields. The embodiments of this invention involve the combination of the graph and topic methods, and the use semantic features derived from DiversityPathMining and topic features derived from bio-entity topic model together. Either feeds to existing machine learning approaches (i.e., decision tree, random forest) or other traditional classifiers that are used to calculate the significance of predication based on the normalized sum of weighted features (i.e., semantic feature and topic feature)

The feature selection of the present invention looks beyond the current direct features, but also go deeper into the indirect features which are hidden between the connections of datasets and the heterogeneity of datasets.

Embodiments of the invention include a semantic feature (SSDD) which is based on the heterogeneity of linked datasets and their semantic structure which is usually indirect and hidden. The disclosed methods below are used to identify SSDD which reflect hidden path patterns and semantic connections. SSDD may dramatically improve the machine learning accuracy

Other embodiments of the invention include a topic feature. The topic feature is calculated based on the textual information about the entities or objects, and the contextual information surrounding these entities and objects, which usually are either ignored or difficult to calculate. However, by organizing the disparate data as disclosed below, adding these topic features becomes feasible in the inventive method.

Embodiments of the invention provide heterogeneity, wherein different datasets are integrated together. By focusing on the datasets heterogeneity, the integrated Linked Data may form the heterogeneous graphs where each node represents different types of entities and each edge represents different types of relationships. The heterogeneity is considered into the path pattern analysis, therefore also included in SSDD features. Looking at disparate datasets with the focus on how to integrate them together to provide the diverse and heterogeneous perspectives provides several advantages for the inventive method.

In one embodiment, a candidate generation step involves creating graphs with information fields from the plurality of datasets as nodes, then creating smaller graphs containing source and sink vertices based on heuristic values. An electrical network computation step involves representing graphs as an electrical circuit to calculate the voltage of each node and the current of each edge by solving a system of linear equations. A diverse subgraph generation step involves selecting paths that carry the larger amount of current and have more new nodes in an iterative process. With each iteration, the path that scores the highest marginal current per number of existing types of nodes is selected and added to the diverse subgraph.

In one aspect, the present invention involves a method and system for semantic analysis of disparate data, in an environment having a plurality of datasets having distinct information fields relating to a topic. Candidate generation involves creating graphs relating to specified information with information fields from the plurality of datasets as nodes. Electrical network computation involves representing graphs as an electrical circuit to calculate the voltage of each node and the current of each edge by solving a system of linear equations. Diverse subgraph generation involves selecting paths that carry the larger amount of current and have more new nodes in an iterative process, wherein each iteration, the path that scores the highest marginal current per number of existing types of nodes is selected and added to the diverse subgraph. Association generation involves scoring the relevancy between selected nodes resulting in a ranked list of a plurality of paths in the subgraph.

Embodiments of the invention may have the candidate generation step involves creating nodes in the form of triples. Other embodiments may have the triples have form of subject, predicate, and object. The candidate generation may further comprises creating smaller graphs containing source and sink vertices based on heuristic values. The electrical network computation may involve assuming the current flows from source to sink. The candidate generation may select a subset of the graphs which maximize a diversity function. The diverse subgraph generation step may include determining semantic identifiers for the paths selected and added to the diverse subgraph. The determination of semantic identifiers may be in part based on at least one of path patterns and semantic connections. The association generation may involve topic analysis of the nodes, wherein each node has a topic value related to textual information related to the node and contextual information about nodes in proximity in the subgraphs. Candidate generation may involves creating nodes associated with different types of entities, and creating links between nodes associated with different types of relationships.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of a network system which embodiments of the present invention may be utilized.

FIG. 2 is a block diagram of a computing system (either a server or client, or both, as appropriate), with optional input devices (e.g., keyboard, mouse, touch screen, etc.) and output devices, hardware, network connections, one or more processors, and memory/storage for data and modules, etc. which may be utilized in conjunction with embodiments of the present invention.

FIG. 3 is a schematic diagrammatic view of semantic data integration through machine learning based on sematic descriptors according to embodiments of the present invention.

FIG. 4 is a network diagram of an example of heterogeneous information network for drug discovery according to embodiments of the present invention.

FIG. 5 is a chart diagram of Bio-Entity Topic Distribution according to embodiments of the present invention.

FIG. 6 is a flow chart network diagram of the methodology of embodiments of the present invention.

FIG. 7 is a heterogeneous network diagram illustrating one embodiment of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

In the field of molecular biology, gene expression profiling is the measurement of the activity (the expression) of thousands of genes at once, to create a global picture of cellular function including protein and other cellular building blocks. These profiles may, for example, distinguish between cells that are actively dividing or otherwise reacting to the current bodily condition, or show how the cells react to a particular treatment such as positive drug reactions or toxicity reactions. Many experiments of this sort measure an entire genome simultaneously, that is, every gene present in a particular cell, as well as other important cellular building blocks.

DNA Microarray technology measures the relative activity of previously identified target genes. Sequence based techniques, like serial analysis of gene expression (SAGE, SuperSAGE) are also used for gene expression profiling. SuperSAGE is especially accurate and may measure any active gene, not just a predefined set. The advent of next-generation sequencing has made sequence based expression analysis an increasingly popular, “digital” alternative to microarrays called RNA-Seq.

Expression profiling provides a view to what a patient's genetic materials are actually doing at a point in time. Genes contain the instructions for making messenger RNA (mRNA), but at any moment each cell makes mRNA from only a fraction of the genes it carries. If a gene is used to produce mRNA, it is considered “on”, otherwise “off”. Many factors determine whether a gene is on or off, such as the time of day, whether or not the cell is actively dividing, its local environment, and chemical signals from other cells. For instance, skin cells, liver cells and nerve cells turn on (express) somewhat different genes and that is in large part what makes them different. Therefore, an expression profile allows one to deduce a cell's type, state, environment, and so forth.

Expression profiling experiments often involve measuring the relative amount of mRNA expressed in two or more experimental conditions. For example, genetic databases have been created that reflect a normative state of a healthy patient, which may be contrasted with databases that have been created from a set of patients with a particular disease or other condition. This contrast is relevant because altered levels of a specific sequence of mRNA suggest a changed need for the protein coded for by the mRNA, perhaps indicating a homeostatic response or a pathological condition. For example, higher levels of mRNA coding for one particular disease is indicative that the cells or tissues under study are responding to the effects of the particular disease. Similarly, if certain cells, for example a type of cancer cells, express higher levels of mRNA associated with a particular transmembrane receptor than normal cells do, the expression of that receptor is indicative of cancer. A drug that interferes with this receptor may prevent or treat that type of cancer. In developing a drug, gene expression profiling may assess a particular drug's toxicity, for example by detecting changing levels in the expression of certain genes that constitute a biomarker of drug metabolism.

For a type of cell, the group of genes and other cellular materials whose combined expression pattern is uniquely characteristic to a given condition or disease constitutes the gene signature of this condition or disease. Ideally, the gene signature is used to detect a specific state of a condition or disease to facilitates selection of treatments. Gene Set Enrichment Analysis (GSEA) and similar methods take advantage of this kind of logic and uses more sophisticated statistics. Component genes in real processes display more complex behavior than simply expressing as a group, and the amount and variety of gene expression is meaningful. In any case, these statistics measure how different the behavior of some small set of genes is compared to genes not in that small set.

One way to analyze sets of genes and other cellular materials apparent in gene expression measurement is through the use of pathway models and network models. Many protein-protein interactions (PPIs) in a cell form protein interaction networks (PINS) where proteins are nodes and their interactions are edges. There are dozens of PPI detection methods to identify such interactions. In addition, gene regulatory networks (DNA-protein interaction networks) model the activity of genes which is regulated by transcription factors, proteins that typically bind to DNA. Most transcription factors bind to multiple binding sites in a genome. As a result, all cells have complex gene regulatory networks which may be combined with PPIs to link together these various connections. The chemical compounds of a living cell are connected by biochemical reactions which convert one compound into another. The reactions are catalyzed by enzymes. Thus, all compounds in a cell are parts of an intricate biochemical network of reactions which is called the metabolic network, which may further enhance PPI and/or DNA-protein network models. Further, signals are transduced within cells or in between cells and thus form complex signaling networks that may further augment such genetic interaction networks. For instance, in the MAPK/ERK pathway is transduced from the cell surface to the cell nucleus by a series of protein-protein interactions, phosphorylation reactions, and other events. Signaling networks typically integrate protein-protein interaction networks, gene regulatory networks, and metabolic networks.

The detailed descriptions which follow are presented in part in terms of algorithms and symbolic representations of operations on data bits within a computer memory representing genetic profiling information derived from patient sample data and populated into network models. A computer generally includes a processor for executing instructions and memory for storing instructions and data. When a general purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself rather as a result of an instruction.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipment through signals configured to particular protocols which may or may not require specific hardware or programming to interact. In particular, various general purpose machines may be used with programs written in accordance with the teachings herein, or it may prove more convenient to construct more specialized apparatus to perform the required method steps. The required structure for a variety of these machines will appear from the description below.

The present invention may deal with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an Object-oriented program. Object-oriented computer programming facilitates the modeling of interactive systems in that each component of the system may be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which may be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks may access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis. A “module” refers to a portion of a computer system and/or software program that carries out one or more specific functions and may be used alone or combined with other modules of the same system or program.

The term “desktop” means a specific user interface which presents a menu or display of objects with associated settings for the user associated with the desktop. When the desktop accesses a network resource, which typically requires an application program to execute on the remote server, the desktop calls an Application Program Interface, or “API”, to allow the user to provide commands to the network resource and observe any output. The term “Browser” refers to a program which is not necessarily apparent to the user, but which is responsible for transmitting messages between the desktop and the network server and for displaying and interacting with the network user. Browsers are designed to utilize a communications protocol for transmission of text and graphic information over a world wide network of computers, namely the “World Wide Web” or simply the “Web”. Examples of Browsers compatible with one or more embodiments of the present invention include the Chrome browser program developed by Google Inc. of Mountain View, Calif. (Chrome is a trademark of Google Inc.), the Safari browser program developed by Apple Inc. of Cupertino, Calif. (Safari is a registered trademark of Apple Inc.), Internet Explorer program sold by Microsoft Corporation (Internet Explorer is a trademark of Microsoft Corporation), the Opera Browser program created by Opera Software ASA, or the Firefox browser program distributed by the Mozilla Foundation (Firefox is a registered trademark of the Mozilla Foundation). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard. Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method). Similarly, JavaScript Object Notation (JSON) may be used to convert between data file formats.

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a first device, e.g. a handheld device, and a second device, e.g. a desktop computer, either via wires or wirelessly. Synchronization ensures that the data on both devices are identical (at least at the time of synchronization).

Data may also be synchronized between computer systems and telephony systems. Such systems are known and include keypad based data entry over a telephone line, voice recognition over a telephone line, and voice over internet protocol (“VoIP”). In this way, computer systems may recognize callers by associating particular numbers with known identities. More sophisticated call center software systems integrate computer information processing and telephony exchanges. Such systems initially were based on fixed wired telephony connections, but such systems have migrated to wireless technology.

In wireless wide area networks, communication primarily occurs through the transmission of radio signals over analog, digital cellular or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), Third Generation (wideband or “SG”), Fourth Generation (broadband or “4G”), personal digital cellular (“PDC”), or through packet-data technology over analog systems such as cellular digital packet data (CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces, “Mobile Software” refers to the software operating system which allows for application programs to be implemented on a mobile device such as a mobile telephone or PDA. Examples of Mobile Software are Java and Java ME (Java and JavaME are trademarks of Sun Microsystems, Inc, of Santa Clara, Calif.), BREW (BREW is a registered trademark of Qualcomm Incorporated of San Diego, Calif.), Windows Mobile (Windows is a registered trademark of Microsoft Corporation of Redmond, Washington), Palm OS (Palm is a registered trademark of Palm, Inc. of Sunnyvale, Calif.), Symbian OS (Symbian is a registered trademark of Symbian Software Limited Corporation of London, United Kingdom), ANDROID OS (ANDROID is a registered trademark of Google, Inc. of Mountain View, Calif.), and iPhone OS (iPhone is a registered trademark of Apple, Inc. of Cupertino, Calif.), and Windows Phone 7. “Mobile Apps” refers to software programs written for execution with Mobile Software.

“PACS” refers to Picture Archiving and. Communication System (PACS) involving medical imaging technology for storage of, and convenient access to, images from multiple source machine types. Electronic images and reports are transmitted digitally via PACS; this eliminates the need to manually file, retrieve, or transport film jackets. The universal format for PACS image storage and transfer is DICOM (Digital imaging and Communications in Medicine). Non-image data, such as scanned documents, may be incorporated using consumer industry standard formats like PDF (Portable Document Format), once encapsulated in DICOM. A PACS typically consists of four major components: imaging modalities such as X-ray computed tomography (CT) and magnetic resonance imaging (MRI) (although other modalities such as ultrasound (US), positron emission tomography (PET), endoscopy (ES), mammograms (MG), Digital radiography (DR), computed radiography (CR), etc. may be included), a secured network for the transmission of patient information, workstations and mobile devices for interpreting and reviewing images, and archives for the storage and retrieval of images and reports. When used in a more generic sense, PACS may refer to any image storage and retrieval system.

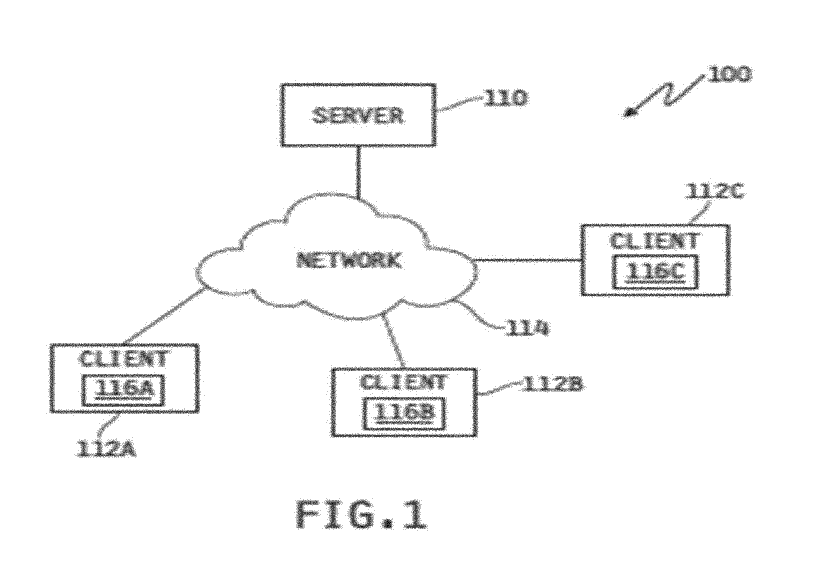

FIG. 1 is a high-level block diagram of a computing environment 100 according to one embodiment. FIG. 1 illustrates server 110 and three clients 112 connected by network 114. Only three clients 112 are shown in FIG. 1 in order to simplify and clarify the description. Embodiments of the computing environment 100 may have thousands or millions of clients 112 connected to network 114, for example the Internet. Users (not shown) may operate software 116 on one of clients 112 to both send and receive messages network 114 via server 110 and its associated communications equipment and software (not shown).

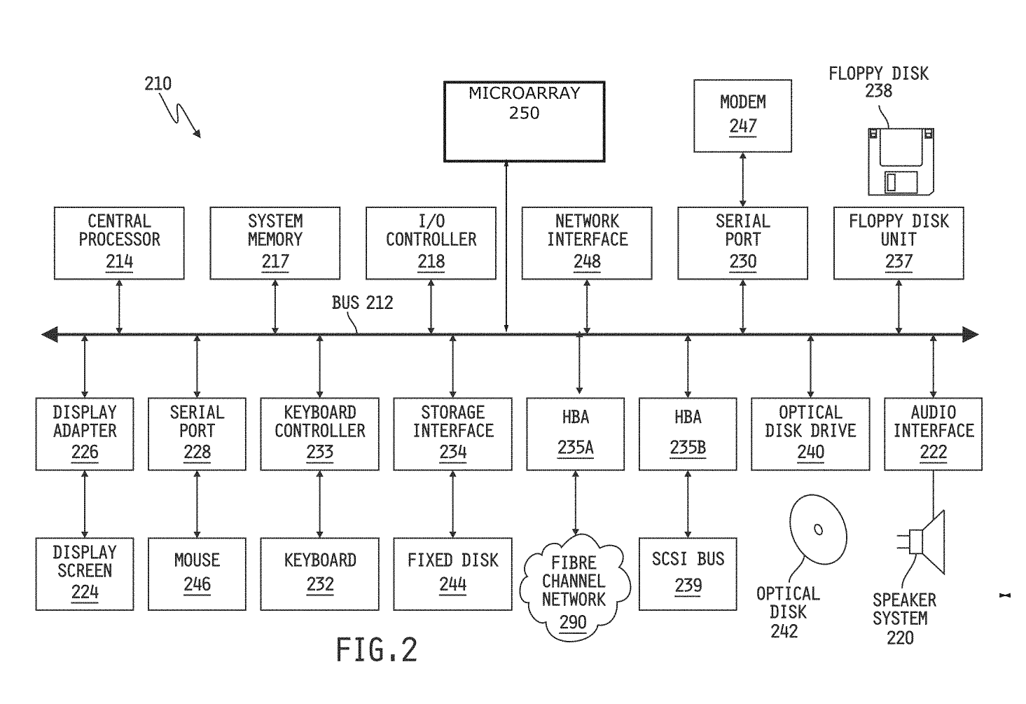

FIG. 2 depicts a block diagram of computer system 210 suitable for implementing server 110 or client 112. Computer system 210 includes bus 212 which interconnects major subsystems of computer system 210, such as central processor 214, system memory 217 (typically RAM, but which may also include ROM, flash RAM, or the like), input/output controller 218, external audio device, such as speaker system 220 via audio output interface 222, external device, such as display screen 224 via display adapter 226, serial ports 228 and 230, keyboard 232 (interfaced with keyboard controller 233), storage interface 234, disk drive 237 operative to receive floppy disk 238, host bus adapter (HBA) interface card 235A operative to connect with Fibre Channel network 290, host bus adapter (HBA) interface card 235B operative to connect to SCSI bus 239, and optical disk drive 240 operative to receive optical disk 242. Also included are mouse 246 (or other point-and-click device, coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown), as previously noted. RAM is generally the main memory into which operating system and application programs are loaded. ROM or flash memory may contain, among other software code, Basic Input-Output system (BIOS) which controls basic hardware operation such as interaction with peripheral components. Applications resident with computer system 210 are generally stored on and accessed via computer readable media, such as hard disk drives (e.g., fixed disk 244), optical drives (e.g., optical drive 240), floppy disk unit 237, or other storage medium (disk drive 237 is used to represent various type of removable memory such as flash drives, memory sticks and the like). Additionally, applications may be in the form of electronic signals modulated in accordance with the application and data communication technology when accessed via network modem 247 or interface 248 or other telecommunications equipment (not shown).

Storage interface 234, as with other storage interfaces of computer system 210, may connect to standard computer readable media for storage and/or retrieval of information, such as fixed disk drive 244. Fixed disk drive 244 may be part of computer system 210 or may be separate and accessed through other interface systems. Modem 247 may provide direct connection to remote servers via telephone link or the Internet via an internet service provider (ISP) (not shown). Network interface 248 may provide direct connection to remote servers via direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. Devices and subsystems may be interconnected in different ways from that shown in FIG. 2. Operation of a computer system such as that shown in FIG. 2 is readily known in the art and is not discussed in detail in this application. Software source and/or object codes to implement the present disclosure may be stored in computer-readable storage media such as one or more of system memory 217, fixed disk 244, optical disk 242, or floppy disk 238. The operating system provided on computer system 210 may be a variety or version of either MS-DOS® (MS-DOS is a registered trademark of Microsoft Corporation of Redmond, Wash.), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux® (Linux is a registered trademark of Linus Torvaids of Portland, Oreg.), or other known or developed operating system. In some embodiments, computer system 210 may take the form of a tablet computer, typically in the form of a large display screen operated by touching the screen. In tablet computer alternative embodiments, the operating system may be iOS® (iOS is a registered trademark of Cisco Systems, Inc. of San Jose, Calif., used under license by Apple Corporation of Cupertino, Calif.), Android® (Android is a trademark of Google Inc. of Mountain View, Calif.), Blackberry® Tablet OS (Blackberry is a registered trademark of Research In Motion of Waterloo, Ontario, Canada), webOS (webOS is a trademark of Hewlett-Packard Development Company, L.P. of Texas), and/or other suitable tablet operating systems.

Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks. Although the signals of the above described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

One peripheral device particularly useful with embodiments of the present invention is microarray 250. Generally, microarray 250 represents one or more devices capable of analyzing and providing genetic expression and other molecular information from patients. Microarrays may be manufactured in different ways, depending on the number of probes under examination, costs, customization requirements, and the type of analysis contemplated. Such arrays may have as few as 10 probes or over a million micrometre-scale probes, and are generally available from multiple commercial vendors. Each probe in a particular array is responsive to one or more genes, gene-expressions, proteins, enzymes, metabolites and/or other molecular materials, collectively referred to hereinafter as targets or target products.

In some embodiments, gene expression values from microarray experiments may be represented as heat maps to visualize the result of data analysis. In other embodiments, the gene expression values are mapped into a network structure and compared to other network structures, e.g. normalized samples and/or samples of patients with a particular condition or disease. In either circumstance, a simple patient sample may be analyzed and compared multiple times to focus or differentiate diagnoses or treatments. Thus, a patient having signs of multiple conditions or diseases may have microarray sample data analyzed several times to clarify possible diagnoses or treatments.

It is also possible, in several embodiments, to have multiple types of microarrays, each type having sensitivity to particular expressions and/or other molecular materials, and thus particularized for a predetermined set of targets. This allows for an iterative process of patient sampling, analysis, and further sampling and analysis to refine and personalize diagnoses and treatments for individuals. While each commercial vendor may have particular platforms and data formats, most if not all may be reduced to standardized formats. Further, sample data may be subject to statistical treatment for analysis and/or accuracy and precision so that individual patient data is a relevant as possible. Such individual data may be compared to large databases having thousands or millions sets of comparative data to assist in the experiment, and several such databases are available in data warehouses and available to the public. Due to the biological complexity of gene expression, the considerations of experimental design are necessary so that statistically and biologically valid conclusions may be drawn from the data.

Microarray data sets are commonly very large, and analytical precision is influenced by a number of variables. Statistical challenges include taking into account effects of background noise and appropriate normalization of the data. Normalization methods may be suited to specific platforms and, in the case of commercial platforms, some analysis may be proprietary. The relation between a probe and the mRNA that it is expected to detect is not trivial. Some mRNAs may cross-hybridize probes in the array that are supposed to detect another mRNA. In addition, mRNAs may experience amplification bias that is sequence or molecule-specific. Thirdly, probes that are designed to detect the mRNA of a particular gene may be relying on genomic Expression Sequence Tag (EST) information that is incorrectly associated with that gene.

Machine Learning is a powerful way for computers to make statistical predictions by identifying relationships between a set of descriptors and a variable that one is trying to predict. Standard practice is for these descriptors to be simple data points. Embodiments of the invention includes new processes to generate new kinds of descriptors, semantic substructure derived descriptors (SSDD's) that encode much more information than regular descriptors. The heterogeneity of linked datasets and their semantic structure makes the relationships between the datum represented by the descriptors usually indirect and hidden. By use of the inventive methods disclosed below to identify SSDD which reflect hidden path patterns and semantic connections. SSDD may then dramatically improve the machine learning accuracy and which our initial embodiments have demonstrated vastly improve the accuracy of machine learning predictions.

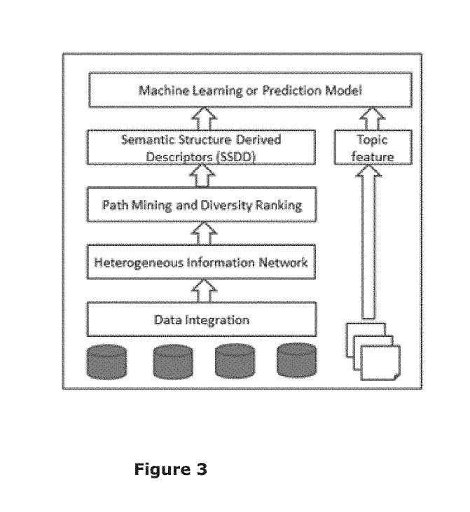

SSDD's are created by identifying semantic substructures in semantic data networks using a software module disclosed in further detail below. These semantic substructures are then transformed into categorical descriptors for machine learning using a series of methodological steps shown in FIG. 3 that draw together domain knowledge and identified patterns. Heterogenity is achieved by integrating different datasets together (300) and focusing on their heterogeneity so that the integrated Linked Data form the heterogeneous graphs where each node represents different types of entities and each edge represents different types of relationships. The heterogeneity is considered and factored into the path pattern analysis, therefore also included in SSDD features 306. Looking at disparate datasets with the focus on how to integrate them together to provide the diverse and heterogeneous perspectives is another innovation in several embodiments of the methods of the present invention.

Embodiments of the present invention may utilize a Heterogeneous Information Network (HIN) 302. In pharmaceutical and healthcare markets, the big data challenge is that isolated datasets with enriched data semantics need to be integrated to predict hidden relations. Those data are normally stored in relational databases and are not the ideal storage format to reflect meaning and facilitate integration. Embodiments of the present invention converts these datasets stored in different formats into a unified format that contains a subject, predicate, and object. These data triples may be stored in three columns or treated as a graph database, in which the subject and object are nodes, and the predicate is the edge connecting the subject and object. The attributes about subject, object, and predicate are stored in a separate relational table. Those attributes are data type attributes meaning that the values for these attributes are numbers, strings, dates or any common data type value. Each subject or object has a unique identifier, which is also stored in the same relational table. Unlike the prior art (RDF), our triples do not use a Universal Resource Identifier (URI) as an identifier for an object, and we also store the triples in a relational table. So, all databases are converted into triples and a separate relational table. These triples may form a heterogeneous information network. For example, converting a dataset of information about drugs, a dataset about genes, and a dataset about side effects, according to embodiments of the invention produces a heterogeneous information network which nodes are bio-entities (i.e., subjects and Objects), and edges are relations between two bio-entities (i.e., predicates), see FIG. 3. Embodiments of the present invention are more convenient and efficient than RDF. Such embodiments may easily handle values with unit measures that are still under the research in the semantic community.

Path Mining and Diversity Ranking 304 are used in embodiments of the present invention to identify path patterns. For example, in the biomedical domain, connections or paths between compounds and genes may reveal potential subjects for drug discovery experiments. There may exist too many paths between any given drug and target pair—ranking is an intuitive and practical way to solve this problem. While many studies have been devoted to result diversification in information retrieval (Drosou, M., & Pitoura, E. (2010). Search result diversification. SIGMOD Record, 39 (1), 41-47.) (the disclosures of which are incorporated by reference herein), little is done with diversification in association search in the semantically annotated heterogeneous networks. Result diversification implies a trade-off between being relevant and being diverse. However, the ranking indicators of semantic paths proposed in previous studies, such as path length, class popularity, and class hierarchy (Aleman-Meza, B., Halaschek, C., Arpinar, B. I., & Sheth, A. (2003). Context-aware semantic association ranking. In Semantic Web and Databases Workshop Proceedings, 33-50, Berlin, Germany.; Anyanwu, K., Maduko, A., & Sheth, A. (2005). SemRank: ranking complex relationship search results on the semantic web. Paper presented at the 14th international conference on World Wide Web.) (the disclosures of which are incorporated by reference herein) do not address the semantic aspects of those paths. Processes are segmented from each other and information from one set needs to be provided to subsequent steps, using the knowledge perspectives local to each step.

Embodiments of the present invention use the Diverse top-k Path Extraction (or “DiversityPathMining”) Algorithm which may be described as:

Given: an HIN G, source node x_s, and sink node x_e from G

Find: a connected subgraph G′ composed of the top-k paths between x_s and x_e that maximizes the diversity function D(G′,k).

While the diversity function may have different definitions, more paths generally add to the diversity of the set. Thus the diversity function D(G,k) implies a competing balance between relevance and diversity, using the minimum number of paths (i.e., most informative paths) to sketch as much of the semantic diversity as possible. The diversity function D(G,k) may be refined based on different applications and how users define the diversity in their application.

The DiversityPathMining algorithm includes three steps or modules:

The pre-processing step (or candidate generation) in candidate generation, a smaller graph containing the source and sink vertices are created based on heuristics (e.g., node degree), to determine a connection between specified information available, e.g., between a drug (source) and a target (sink). Nodes in the general neighborhood of the source and sink with higher heuristic values are favored in the candidate graph. The candidate graph captures as many potential nodes relevant to the source and sink as possible while restricting the computing costs to an acceptable level.

Electrical network computation: the candidate graph is viewed as an electrical circuit. According to Ohm's law and the conservation of electricity, the voltage of each node and the current of each edge are obtained by solving a system of linear equations. Currents carried by all the source-to-sink paths are calculated.

Diverse subgraph generation: paths that carry the larger amount of current and that have more new nodes are selected in an iterative process. In each iteration, the path that scores the highest marginal current per number of existing types of nodes is selected and added to the diverse subgraph. This allows the paths to be scored, and then selected and ranked to show the most relevant nodes and paths.

Testing of this algorithm shows promising results. Considering drugs for hepatitis, rosiglitazone is one of several thiazolidinedione on the market for diabetes. The drug works by binding to one of the PPAR nuclear receptors (PPAR-gamma), which in turn increases sensitivity to insulin in cells. However, drugs that activate nuclear receptors have been linked to problematic side effects including liver toxicity and hepatitis problems. Recently, concerns have emerged about cardiac problems (including stroke) from rosiglitazone, and it has been recommended for withdrawal in Europe and restricted use in the U.S. Initial testing presents the set of most informative and diverse associations between the drug and the potential side effects, which shows different causes of the hepatitis side effect.

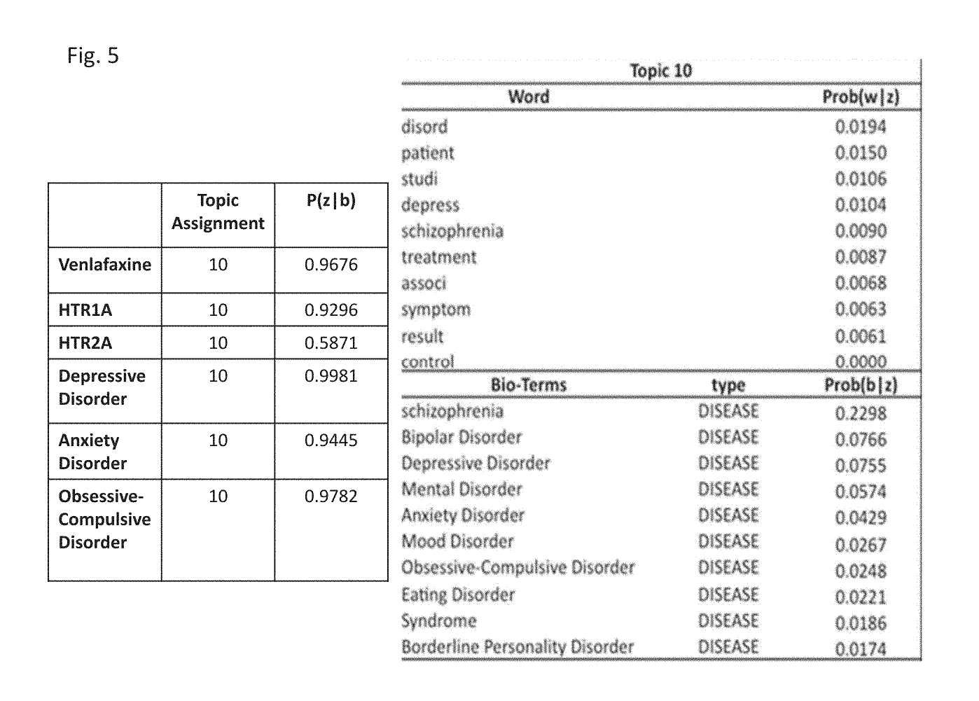

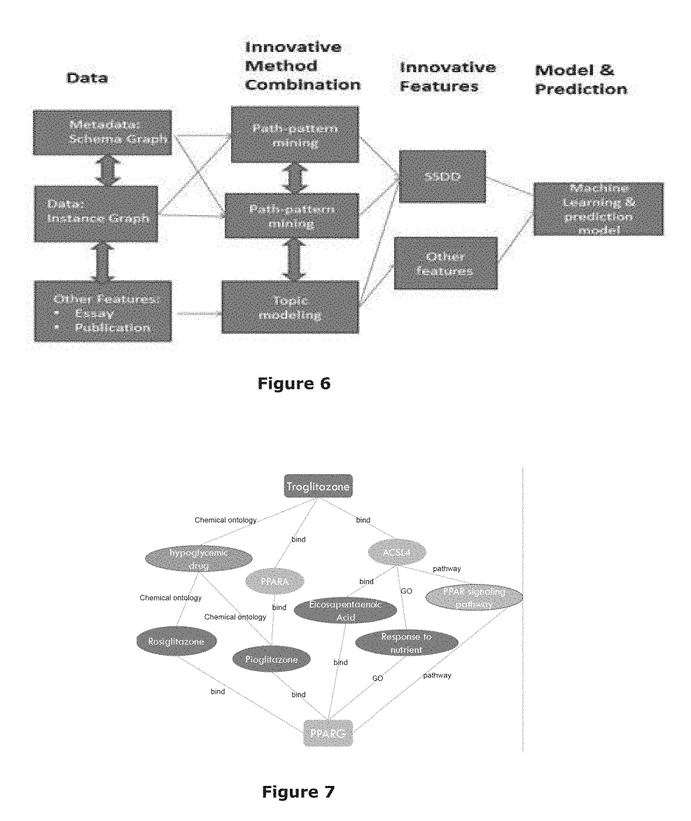

Bio-entity topic modeling 310 may be used to extend the current topic modeling algorithm (LDA) to include bio-entity as a variable to calculate the bio-entity topic probability distribution, see the Bio-Entry Topic Distribution shown in the charts of FIG. 5.

The topic probability distribution of a bio-entity may be viewed as a vector. The topic similarity between any given two bio-entities may be calculated using Kullback-Leider divergence (KL divergence). The topic diversity of a bio-entity may be measured using entropy. These are different features used for a machine learning approach which is described in greater detail below. The topic feature is calculated based on the textual information about the entities or objects, and the contextual information surrounding these entities and objects, which usually are either ignored or difficult to calculate. Adding these topic features is one of the innovations in embodiments of the methods of the present invention.

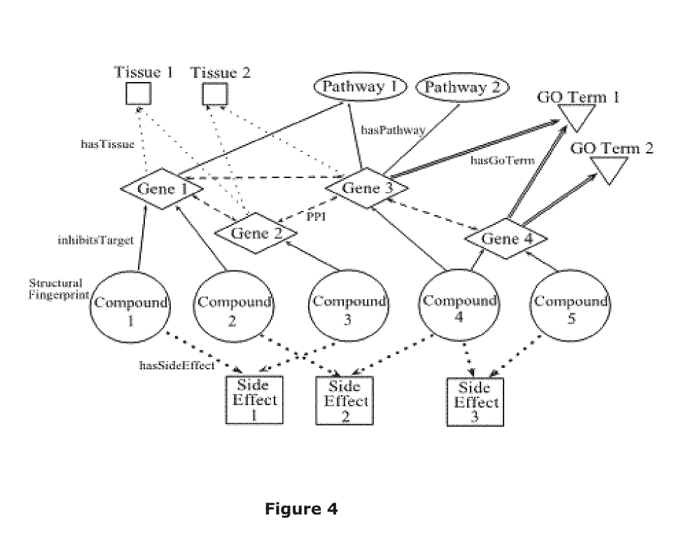

Semantic substructure derived descriptors (SSDD's) are used in embodiments of the invention, for example, in FIG. 4, the DiversityPathMining algorithm may find the following top-ranked path patterns:

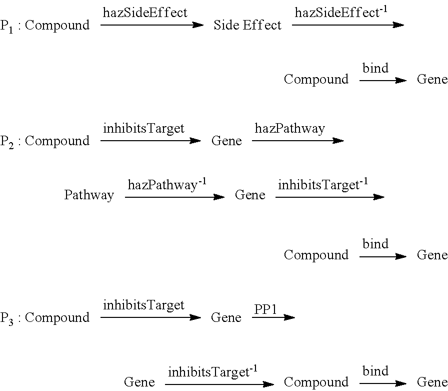

These identified exemplary path patterns are used to calculate the semantic scores for any given pair of drug and target. There are different ways to calculate the semantic scores which depends on the requirement of specific application and user request.

Embodiments of this invention involve the combination of the graph and topic methods, and the use semantic features derived from DiversityPathMining and topic features derived from bio-entity topic model together. Either feeds to existing machine learning approaches (i.e., decision tree, random forest) or other traditional classifiers that are used to calculate the significance of predication based on the normalized sum of weighted features (i.e., semantic feature and topic feature). Various aspects of embodiments of the present invention are disclosed below.

Data Integration 600 binvolves converting different datasets stored in different formats into a triple format (subject, predicate, object). Metadata 602, Instance Graph 604, and Publications 606 may be involved. The datatype properties and values are stored in a separate relational table. The integrated result is a connected graph between entities.

Innovative Method Combination 610 involves combining several published methods together to generate semantic structure derived descriptors (SSDD), including Path-pattern mining 612 and topic modeling 614. By mapping the text of the original descriptors to unambiguous references implied by the path patterns, more descriptive and effective SSDD's may be derived.

The derived SSDDs 622 consider also consider other features 624 such as the path patterns of the connected subgraph between two given nodes and the diversity of the subgraph. Together with topic features derived from textual data, SSDDs are fed to prediction models 630 including machine learning approaches 632.

Interpretability and Transparency provide further advantages of embodiments of the invention. This involves allowing for interpretation of the association between two variables derived from machine learning approaches, by showing the details of the subgraphs on how these variables are connected and why some paths are important given the identified path patterns.

The approach of embodiments of the present invention have been applied to drug discovery targeted therapeutics, clinical trial, pharmaceutical, chemical, biological, healthcare, healthcare accounting, healthcare risk adjustment, and other applications. Specifically, embodiments of the invention have been applied to drug discovery and the predictions compared to other existing research using lab experiments, the result being that area under an ROC curve is above 0.9 for embodiments of the present invention.

Exemplary embodiments of the invention produce, for the SSDD process, a graph with nodes and edges expressed in terms of the enriched descriptors, rather than the descriptors in the raw data. By themselves, these new descriptors in themselves are not the end product to the user. Rather, these new descriptors are useful to create better answers from the association-finding process.

For the association-finding, the output involves a list of the nodes that are the “best” associations with the selected starting node, along with the association score for each of those best nodes. The type of the node isn't necessarily a protein target, although identifying such protein targets are often a common objective. Alternatively, the starting node may be a protein and the relevant identification may be the most tightly associated compounds, or perhaps instead the desired identification involves obtaining the most highly associated diseases or adverse events with that marker, protein or compound.

A heterogeneous network consisting of 295,897 nodes and 727,997 edges was constructed from 17 public data sources pertaining to drug target interaction, and a network node diagram of this network is illustrated in FIG. 7. Every node and edge was semantically annotated using a systems chemical biology/chemogenomics ontology. A single node is an instance of a corresponding class, for example: a node for the drug Troglitazone is an instance of class Chemical Compound. We term paths of nodes and edges that share the same semantics (but different data) path patterns—each path is an instance of a path pattern. For example, the path from node Troglitazone to node Glitazone (receptor via Long-chain-fatty-acid CoA ligase 4) and Eicosapentaenoic acid is an instance of the path pattern. We may interpret this path as indicating Troglitazone could bind to ACSL4 which shares compound Eicosapentaenoic acid with target PPARG. With the assumption that two nodes are associated if they link to at least one other node, or their linked nodes are linked, their relations may be assessed by the analysis of the links (or paths) between the two nodes. A Receiver Operating Characteristic (ROC) curve is a graphical plot illustrating the performance of a binary classifier system. The curve is created by plotting the true positive rate (TPR) against the false positive rate (FPR) at various thresholds.

Different from companies (i.e. Franz, I/O Informatics) which are using semantic technologies, most of these companies use RDF triples following the W3C standards which use URIs to uniquely identify entity and store datatype values in the RDF triples. Their methods may be generally summarized as: data integration for search using Sparql (RDF query language, I/O Informatics) and reasoning based on integrated datasets and ontologies (Franz). Different than these methods, embodiments of the present invention treat triples as graphs and apply bio-entity topic modeling and DiversityPathMining to identify path patterns and then use these path patterns to derive SSDDs. By focusing on using triple graphs, embodiments of the present invention derive innovative features to feed to machine learning algorithms. This is one of the unique differences between embodiments of the present invention and other semantic technologies.

Embodiments of the present invention are also different from software provided by a plethora of machine learning companies—these companies do not consider the semantic features of connected datasets. Most such software use numeric data about frequency, usage, or number of hits or visits to predict trends. The limitation of those approaches is the inability to handle diverse datasets, especially those datasets with enriched semantics common in healthcare applications. Secondly, that software does not consider the semantic substructure of the datasets, which is significant. Embodiments of the present invention consider these SSDDs and topic features and apply them in machine learning. Another difference is that using the techniques of embodiments of the invention allows for the explanation of the results. Two things are predicted to be associated together, for example, that a drug has a high chance to bind a target, embodiments of the present invention may explain why this could happen by showing their semantic substructures (e.g., semantic subgraphs). So with embodiments of the present invention, machine learning is no longer a black box—results from machine learning using outputs of embodiments of the present invention may be interpretable.

The following references were used in the development of the present invention, and the disclosures of which are explicitly incorporated by reference herein:

Chen B, Ding Y, Wild D J (2012) Assessing Drug Target Association Using Semantic Linked Data. PLoS Comput Biol 8(7): e1002574. doi :10.1371/journal.pcbi.1002574 (see http://journals.plos.org/ploscompbiol/article?id=10.1371/journal.pcbi.1002574)

He. B., Ding, Y., Tang, J., Reguramalingam, V., & Bollen, J. (2013). Mining diversity subgraph in multidisciplinary scientific collaboration networks: A meso perspective. Journal of Infometrics, 7(1), 117-128. (see http://info.slis.indiana.edu/˜dingying/Publication/Diversity-final.pdf)

Wang H, Ding Y, Tang J, Dong X, He B, Qiu J, et al. (2011) Finding Complex Biological Relationships in Recent PubMed Articles Using Bio-LDA. PLoS ONE 6(3): e17243. doi:10.1371/journal.pone.0017243 (see http://journals.plos.org/plosone/article?=10.1371/journal.pone.0017243).

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A method for semantic analysis of disparate data, in an environment having a plurality of datasets having distinct information fields relating to a topic, the method comprising the steps of:
candidate generation, involving creating graphs relating to specified information with information fields from the plurality of datasets as nodes;
electrical network computation, involving representing graphs as an electrical circuit to calculate the voltage of each node and the current of each edge by solving a system of linear equations; and
diverse subgraph generation, involving selecting paths that carry the larger amount of current and have more new nodes in an iterative process, wherein each iteration, the path that scores the highest marginal current per number of existing types of nodes is selected and added to the diverse subgraph; and
association generation between selected nodes scored by relevancy resulting in a ranked list of a plurality of paths in the subgraph, the associate generation including creating a data set stored in non-transient memory, the data set including the ranked list.

2. The method of claim 1 wherein the candidate generation step involves creating nodes in the form of triples.

3. The method of claim 2 wherein triples have the form of subject, predicate, and object.

4. The method of claim 3 wherein the candidate generation step further comprises creating smaller graphs containing source and sink vertices based on heuristic values.

5. The method of claim 4 wherein the electrical network computation step involves assuming the current flows from source to sink.

6. The method of claim 1 wherein the candidate generation step selects a subset of the graphs which maximize a diversity function.

7. The method of claim 1 wherein the diverse subgraph generation step includes determining semantic identifiers for the paths selected and added to the diverse subgraph.

8. The method of claim 7 wherein determination of semantic identifiers is in part based on at least one of path patterns and semantic connections.

9. The method of claim 1 wherein the association generation step involves topic analysis of the nodes, wherein each node has a topic value related to textual information related to the node and contextual information about nodes in proximity in the subgraphs.

10. The method of claim 1 wherein the candidate generation step involves creating nodes associated with different types of entities, and creating links between nodes associated with different types of relationships.

11. A system for semantic analysis of disparate data, the system comprising:
a processor and related memory;
a plurality of datasets having distinct information fields relating to a topic, the plurality of datasets being accessible by the processor and memory;
candidate generation module accessible by the processor and memory, having software instructions capable of enabling the processor and memory to create graphs relating to specified information with information fields from the plurality of datasets as nodes;
electrical network computation module accessible by the processor and memory, having software instructions capable of enabling the processor and memory to represent graphs as an electrical circuit to calculate the voltage of each node and the current of each edge by solving a system of linear equations; and
diverse subgraph generation module accessible by the processor and memory, having software instructions capable of enabling the processor and memory to select paths that carry the larger amount of current and have more new nodes in an iterative process, wherein each iteration, the path that scores the highest marginal current per number of existing types of nodes is selected and added to the diverse subgraph; and
association generation module accessible by the processor and memory, having software instructions capable of enabling the processor and memory to associate between selected nodes scored by relevancy resulting in a ranked list of a plurality of paths in the subgraph, said association generation module including a data set creation module for creating a data set in non-transient memory including the ranked list.

12. The system of claim 11 wherein the candidate generation module involves creating nodes in the form of triples.

13. The system of claim 12 wherein triples have the form of subject, predicate, and object.

14. The system of claim 13 wherein the candidate generation module further comprises creating smaller graphs containing source and sink vertices based on heuristic values.

15. The system of claim 14 wherein the electrical network computation module involves assuming the current flows from source to sink.

16. The system of claim 11 wherein the candidate generation module selects a subset of the graphs which maximize a diversity function.

17. The system of claim 11 wherein the diverse subgraph generation module includes determining semantic identifiers for the paths selected and added to the diverse subgraph.

18. The system of claim 17 wherein determination of semantic identifiers is in part based on at least one of path patterns and semantic connections.

19. The system of claim 11 wherein the association generation module involves topic analysis of the nodes, wherein each node has a topic value related to textual information related to the node and contextual information about nodes in proximity in the subgraphs.

20. The system of claim 11 wherein the candidate generation module involves creating nodes associated with different types of entities, and creating links between nodes associated with different types of relationships.
